(19) United States
(12) Patent Application Publication
(10) Pub. No.: US 2011/0309005 A1
(43) Pub. Date: Dec. 22, 2011

(54) YARN SORTING SYSTEM

(76) Inventors: William Oscar Ingram, III, Valley, AL (US); Alison Harper, Valley, AL (US); Eddie Smith, Newnan, GA (US); Horace Eddie Bradley, JR., Shanghai (CN)

(21) Appl. No.: 13/150,471

(22) Filed: Jun. 1, 2011

Related U.S. Application Data
(60) Provisional application No. 61/396,697, filed on Jun. 1, 2010.

(51) Int. Cl. B07C 5/00; B07C 5/16

(52) U.S. Cl. 209/596; 209/552; 209/592

(57) ABSTRACT

Yarn package sorting conveyer systems and methods using multiple conveyers based on weights, colors or other characteristics of the packages or yarns. The system may include a first conveyer that serves as a timing belt, a second conveyer that serves as a weighing belt, and a third conveyer that serves as a sorting/exit belt, but fewer or more conveyers and alternative conveyer mechanisms may be used. The conveyers may be controlled by programmable logic controllers (PLCs) with touch screen interfaces or other suitable control mechanisms and systems.

### RELATED APPLICATIONS

This application claims the benefit of U.S. Provisional Application Ser. No. 61/396,697 filed Jun. 1, 2010 titled “Yarn Sorting System,” the contents of which are hereby incorporated by reference.

### FIELD OF THE INVENTION

Embodiments relate to systems and methods for sorting yarn packages.

### BACKGROUND

In manufacturing carpet, such as carpet tiles that together form a floor covering, different yarn types and colors are often used. Including more colors and more complicated patterns in carpet designs increases the number of different yarns and otherwise complicates the manufacturing process. This is especially true when a carpet is customized based on a particular customer's requirements because such customized orders tend to require specialized yarns that are not used as frequently.

Yarn wound onto a cardboard or plastic cylindrical core or “bobbin” or a conical “cone” is referred to as a “yarn package.”

Conventionally, after a job/order is run to manufacture carpet, the leftover yarn in a yarn package is removed from the existing package bobbin or cone and rewound with other yarn to create a new package of yarn. It is generally necessary to reprocess the yarn package in such a manner before it can be reused, because there has otherwise been no way of knowing how much yarn is left in the package. However, these backwinding and re-coning processes are time consuming, relatively labor intensive, and imprecise. In some cases, there is enough yarn remaining in a package to be reused in some jobs without reprocessing. Thus, there is a need to be able to determine how much yarn remains in a package to determine whether reprocessing is required, or whether there is enough yarn to be used in another job. Such information would be especially useful when dealing with small orders or yarn packages of a small size, such as those weighing under one pound, because it is particularly difficult to determine whether sufficient yarn is left on yarn packages that are relatively small in size.

### BRIEF SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

This invention is a yarn sorting conveyer system that comprises multiple conveyers for yarn packages or partial packages. In some embodiments, the system includes a first conveyer, a second conveyer, and a third conveyer. In other embodiments, the system uses more or less than three conveyers. In some embodiments, the conveyers are controlled by programmable logic controllers (PLCs) with touch screen interfaces. Also disclosed are systems and methods of sorting yarn packages based on the weights of the packages or other physical characteristics of the yarn, including color, denier, type (e.g., yarn chemistry, number of plies, etc.).

### BRIEF DESCRIPTION OF THE DRAWINGS

FIG. 1 is an end perspective view of the yarn sorting conveyer system according to one embodiment, shown from the end of the system comprising the first conveyer.

FIG. 2 is another view of the yarn sorting conveyer system of FIG. 1, showing partial yarn packages as they traverse along the first conveyer.

FIG. 3 is a side perspective view of the second conveyer of the yarn sorting conveyer system of FIG. 1.

FIG. 4 is an end perspective view of the opposite end of the yarn sorting conveyer system of FIG. 1, shown from the end of the system comprising the third conveyer.

FIG. 5 is a perspective view of the third conveyer of FIG. 4 illustrating the yarn package pusher assembly.

FIG. 6 is a perspective view of the third conveyer of FIG. 4, showing a yarn package as it traverses along the third conveyer and a yarn package pusher assembly in action.

FIG. 7 is a front view of a touch screen controller of the yarn sorting conveyer system of this invention depicted in FIGS. 1-6.

FIG. 8 is a front view of a printer that can be used with the yarn sorting conveyer system of FIGS. 1-7 and other embodiments.

FIG. 9 schematically illustrates how a yarn package traverses across a yarn sorting conveyer system.

FIG. 10 illustrates placement of eyes along the conveyers.

### DETAILED DESCRIPTION

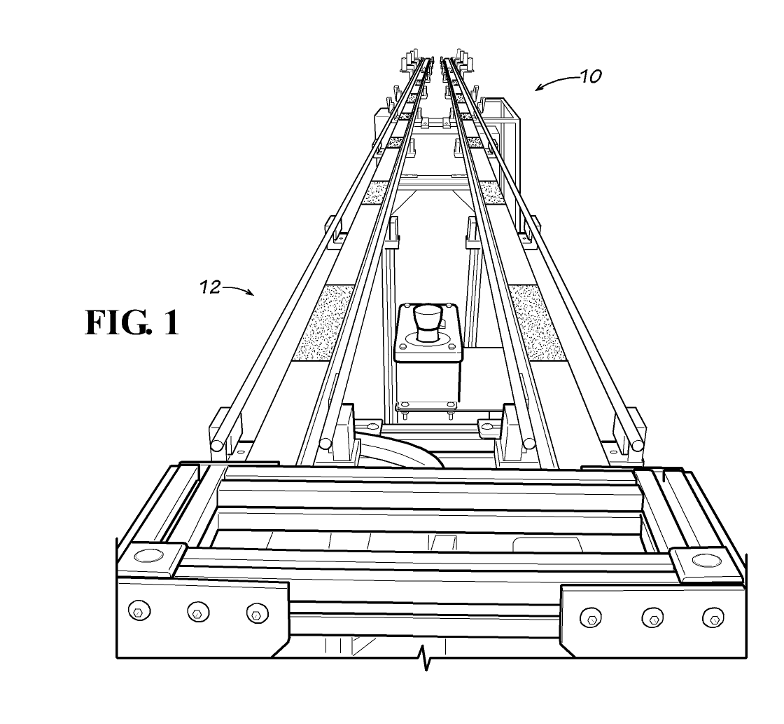

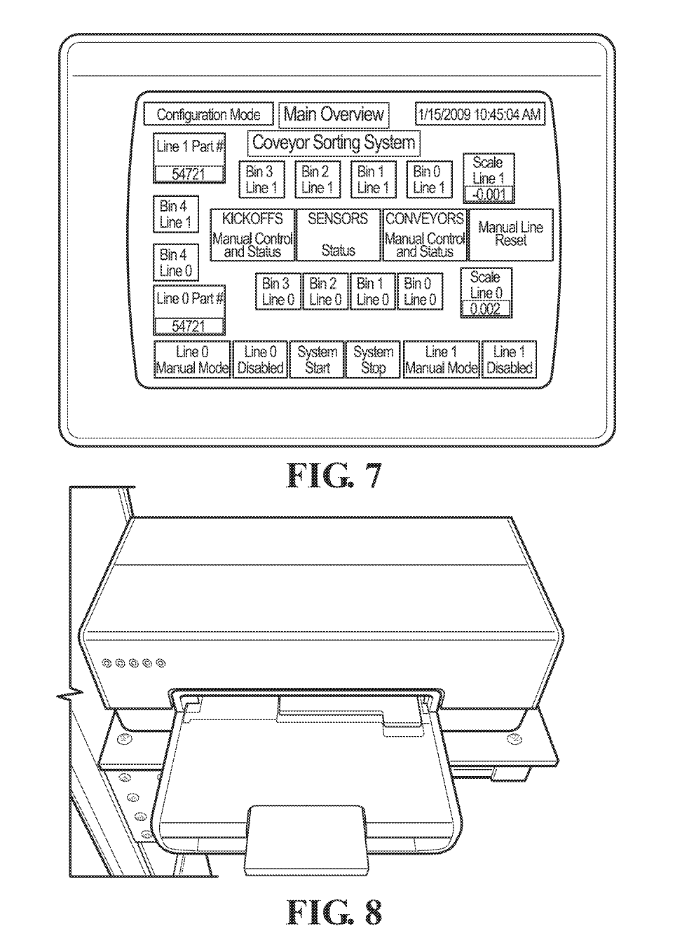

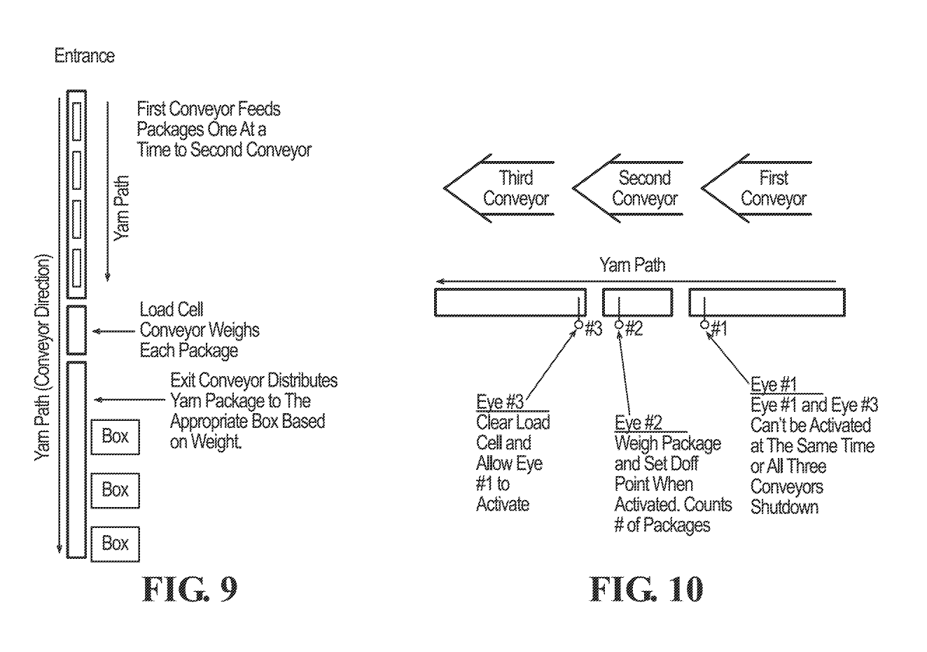

FIGS. 1-8 illustrate one embodiment of a yarn sorting conveyer system 10, which consists of a series of conveyer belts configured to move yarn packages 18 along the system. yarn sorting conveyer system 10 consists of a first conveyer 12, a second conveyer 14, and a third conveyer 16, with all three conveyers operating together. In other embodiments, yarn sorting conveyer system 10 includes more than three conveyer belts and in some embodiments, includes less than three conveyer belts. As described below, each of the first conveyer 12, second conveyer 14, and third conveyer 16 may be used to provide a discrete function in the yarn sorting system 10. In this embodiment, first conveyer 12 serves as a feed/timing belt, second conveyer 14 serves as a weighing belt, and third conveyer 16 serves as a sorting/exit belt. The conveyers are arranged relative to one another and used such that each yarn package is on the weight belt by itself (i.e., without another yarn package) for at least a period of time sufficient so that its weight can be measured.

In certain embodiments, each yarn sorting conveyer system 10 runs independently of another yarn sorting conveyer system. Each conveyer system 10 may include more or less than the three conveyers described and illustrated.

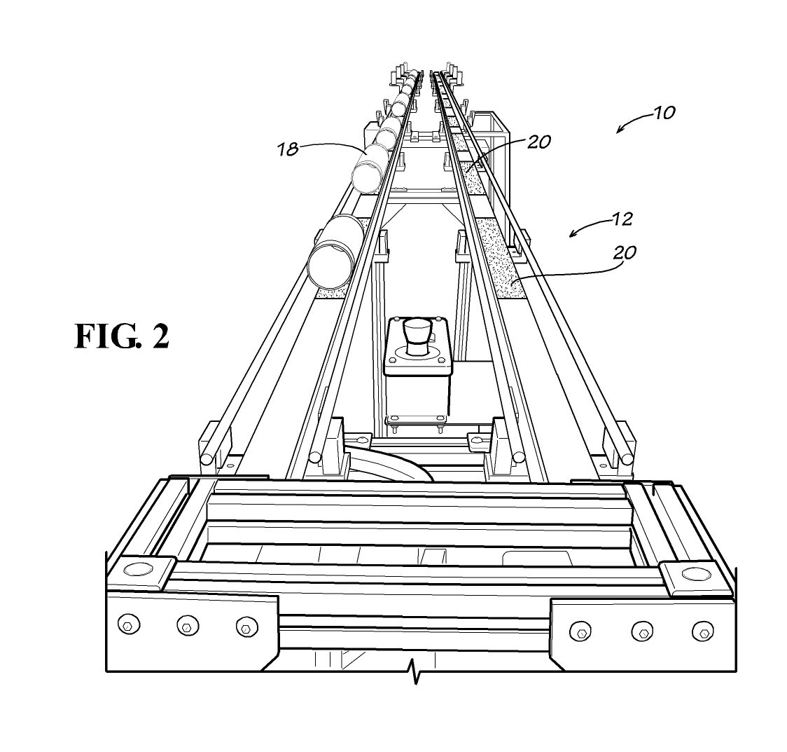

FIG. 2 illustrates how first conveyer 12, which serves as a timing belt, may optionally include markings 20 to indicate where an operator should place yarn packages 18 along the conveyer to ensure that the yarn sorting conveyer system runs most efficiently. Markings 20 are not necessary, and may be spaced further apart or closer together depending on the speed of the conveyer belts and the number of operators operating the conveyer system. First conveyer 12 delivers yarn packages 18 one at a time to second conveyer 14 at appropriate intervals.

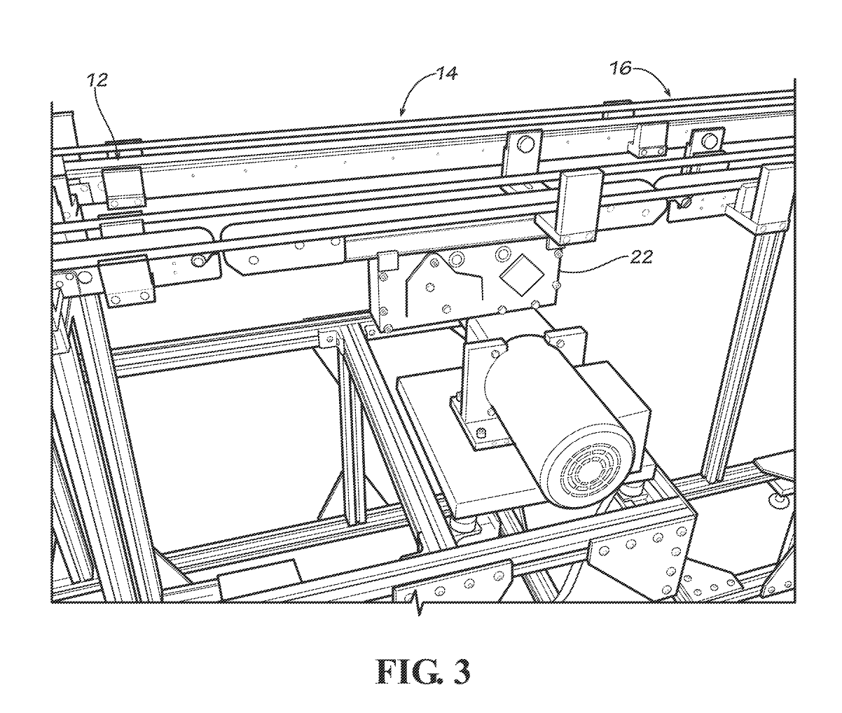

FIG. 3 illustrates one embodiment of the second conveyer 14, which is positioned between first conveyer 12 and third conveyer 16. Second conveyer 14 includes a load cell 22, which weighs each yarn package 18 as it traverses over the load cell 22. Once the load cell 22 discerns the weight of the yarn package 18, the load cell 22 programs the system so that the yarn package 18 is moved from the conveyer at a doff (or removal) point selected based on the weight of the package.

In some embodiments, the yarn sorting conveyer system 10 includes three light based sensors, referred to herein as “eyes.” As illustrated in FIG. 10, one eye is positioned on first conveyer 12, a second eye is positioned on second conveyer 14, and a third eye is positioned on third conveyer 16. When the second eye on the second conveyer 14 is activated, the load cell 22 weighs the yarn package 18 and the doff point at which the particular yarn package 18 will exit the system is assigned to the package 18. The second eye also counts the number of yarn packages 18 moving along the second conveyer 14.

The first and third eyes work together to make sure that the second conveyer 14 is ready to receive an additional yarn package 18. Specifically, a first yarn package 18 must clear the third eye before a second yarn package 18 is permitted to move from the first conveyer 12 to the second conveyer 14. In this way, if a yarn package 18 does not exit from second conveyer 16 (the yarn package 18 does not clear the third eye), then a new yarn package 18 is not permitted to enter second conveyer 16 because the first eye will not activate. In some embodiments, if a yarn package does not clear the third eye (does not exit second conveyer 16), the progress of one or more of the conveyers can be slowed or halted to allow the problem to be automatically and/or manually diagnosed and remedied.

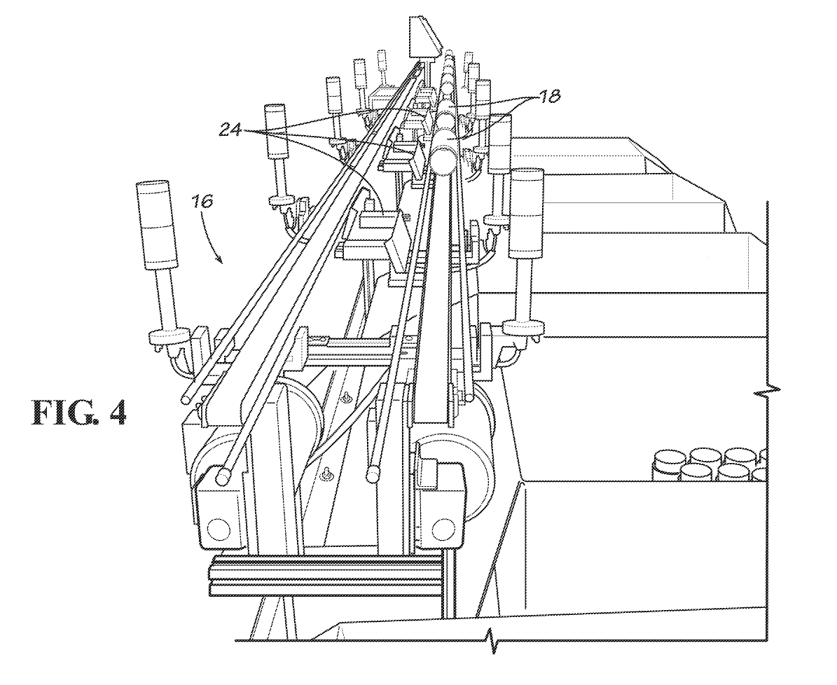

The third conveyer 16 includes a number of yarn package pusher assemblies 24 (shown in FIG. 4) that are each associated with a doff point. Each numbered yarn package 18 travels a specific length of time and/or distance to reach the doff point assigned by the second eye. Once the yarn package reaches the assigned doff point, the yarn package pusher assembly 24 is activated to move the yarn package 18 into the desired bin associated with the assigned doff point. In this way, the yarn packages 18 are sorted by weight. In other words, the yarn packages are placed into different bins based on their respective weights. For example, a first bin may receive yarn packages within a first weight range, a second bin may receive yarn packages within a second weight range, etc. This ensures that each yarn package 18 is associated with the correct weight.

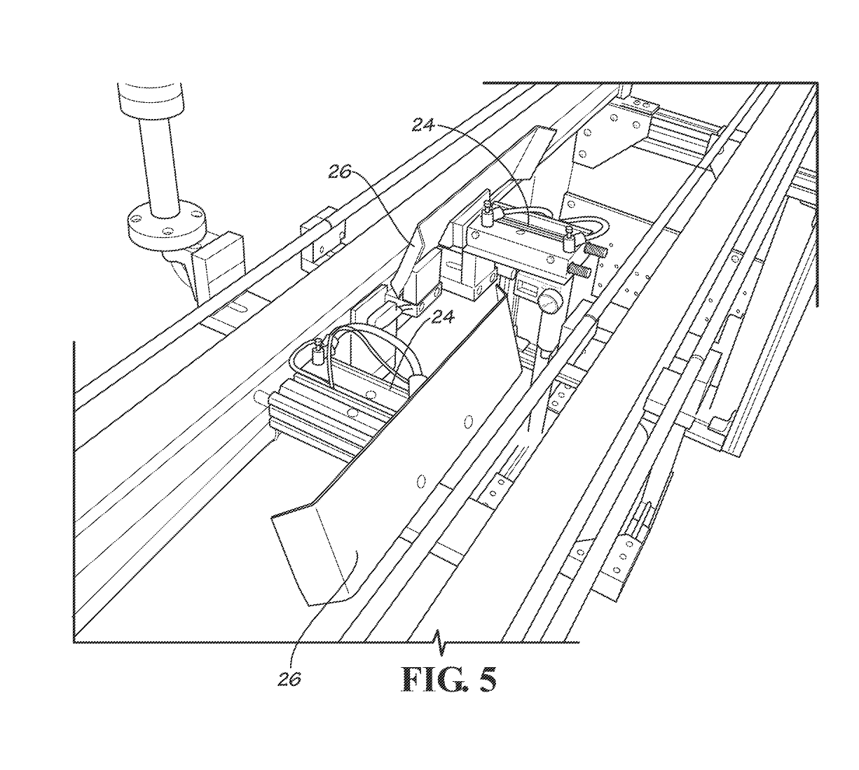

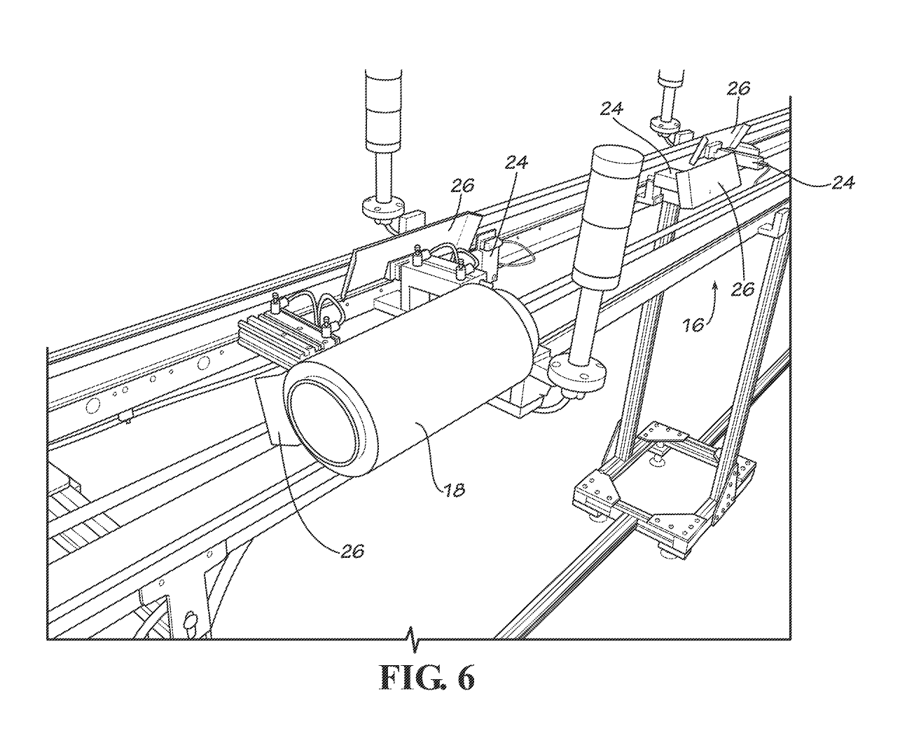

In the embodiment shown in FIGS. 5-6, yarn package pusher assembly 24 comprises a hydraulic or other suitable type of cylinder having right and left facing plates 26 that move from left to right to kick, push, or otherwise cause the yarn packages 18 to move into the appropriate bins. Numerous other devices can be used to reposition the yarn packages from conveyor belt 16 to one of the bins.

Based on the weight of the yarn package 18, the length of the yarn remaining on the package can be estimated. Such estimates may be improved using the weight of the tube or core on which the yarn is wound (without the yarn) and/or the type of yarn on the package (i.e., whether 1 ply or 2 ply). Other information may be used to further refine the yarn length estimate as may be appropriate.

In one embodiment, the yarn sorting conveyer system includes two independently controlled conveyer sequences that each process a set number of doff points. For instance, such a system can include five doff points. Each of the doff points can be programmed using a touch screen PLC interface to correspond to a selected weight range. The PLCs also can be used to control the timing and the speed of the three conveyers and the range of weights for each doff point. Information about each yarn type (i.e., whether 1 ply or 2 ply, etc.) can be entered into the touch screen PLC.

A hopper feed belt can feed the yarn packages to the first conveyer 12 at timed intervals. Alternatively, an operator can manually place the packages on the conveyer 12, and numerous other techniques and devices can be used for such placement. In some embodiments, the bins into which the packages are placed include a mechanism to ensure that the packages land into the bin at a particular orientation. For example, a bin may include an upright stick or pole that receives the yarn package and ensures that the package is oriented upright in the bin after it slides down the stick/pole. Bar code labels can be created for the yarn packages that are collected in a particular bin using information stored in the PLC. The PLCs may be connected to the system wirelessly, which enables the information to be downloaded and used in other applications.

The system can also include additional sensors. For example, the system may include sensors for detecting and sorting packages based on color. In these sensor-containing embodiments, the sensor may read the color of yarn associated with the yarn package and the system may assign a doff point at which the particular yarn package will exit the system. In this way, the yarn packages can be sorted by color into appropriate bins.

Determining the length of yarn in the package by weighing the package can eliminate the need to unwind the yarn and rewind the yarn into a new package, because the length of yarn remaining in the package can be estimated based on the weight of the package. The yarn may still be unwound and rewound if, for example, it is determined that the amount of yarn remaining in the package is not sufficient to use in another job. Yarn packages that have sufficient yarn, however, can be re-used without additional processing or rewinding/re-coning.

The yarn sorting systems of this invention can thus provide a faster, more efficient, and more accurate system than hand sorting and other conventional re-coning systems. In some instances, yarn sorting by weighing a package may be five times or more faster than unwinding and rewinding a yarn package. Thus, increased efficiencies and reduced labor reduce expenses. Costs may be further reduced if a yarn package can be reused without having to be reprocessed through rewinding. By not rewinding a yarn package, the yarn may retain higher quality, and thus result in higher quality carpet with fewer stops on a tufting machine

Moreover, this yarn sorting system may allow for the use of yarn at a narrower tolerance than if rewinding was used to determine the amount of yarn on the package.

Because measuring the amount of yarn remaining in a yarn packaging by rewinding is not very precise, more yarn than is needed is included in the package to reduce the risk of running out of yarn during a job (in some cases, the yarn packages have 0.1 pounds more yarn than needed to account for variances in the winding process). It is particularly important to be precise when dealing with yarn packages having relatively small weights. Because the disclosed yarn sorting system is more accurate than traditional sorting methods, extra yarn need not be added as a buffer. This further reduces costs associated with wasted yarn.

In addition, information collected while using the sorting yarn conveyer system can be analyzed to determine trends in yarn type distribution and usage, which can be used to optimize the carpet construction process, including portions using the yarn originally on the packages being re-processed

Yarn sorting using the yarn sorting conveyer system described above may involve placing yarn packages having unknown lengths of yarn on a first conveyer that transports the yarn packages to a second conveyer having a load cell. The load cell weighs each yarn package and uses this weight to assign the package with a doff kick off point. The second conveyer then transports the yarn packages to a third conveyer where the yarn package is kicked off when it reaches its assigned doff kick off point. In this way, the yarn packages are sorted by their weights. The weight of the yarn package can then be used to determine the amount of yarn remaining on the package and thus whether the yarn package can be re-used in another job or whether reprocessing is required before the yarn package can be reused. This method may be particularly advantageous when dealing with yarn packages that are not utilized as often, or that have relatively small weights.

Numerous modifications of the structures and methods described above and shown in the drawings may be made without departing from the scope or spirit of the invention. For instance, different conveying systems can be used for moving the partial yarn packages through the weighing and sorting process. As alternatives to conveyor belt systems, conveyor chains, robot arms, pick and place mechanisms, and other suitable systems may be used to weight and sort the packages. Similarly, color sorting or other sorting functionality could be included. For instance, cameras or other color detectors could be appropriately positioned along one of the conveyors to collect color information for use in further sorting the partial packages. As another example, packages could be identified by RFID and/or barcode to facilitate sorting packages of different types of yarns, which could also serve as individual package identifiers for a data collection system. The conveyor system could also be used in conjunction with yarn disposal or yarn/cardboard separation equipment. Yarn packages of different types, colors or other attributes could be purposely mixed to create kits for remote assembly areas or use by others. This process could be performed with or without sorting.

1. A system comprising:
at least one conveyor for moving a yarn package from a loading position to one of a plurality of yarn package receiving bins;
a measurer positioned relative to the at least one conveyer to measure a characteristic of one of the yarn packages while the yarn package is on the at least one conveyer; and
a transfer mechanism associated with each receiving bin for transferring the package into one of the yarn package receiving bins based on the measured characteristic of the yarn package.

2. The system of claim 1, wherein the at least one conveyer comprises three conveyers, wherein:
a first conveyor receives the yarn package at the loading position and feeds the yarn package to a second conveyor;
the second conveyor measures the characteristic of the yarn package and conveys the yarn package to a third conveyor; and
the third conveyor conveys the yarn package to the appropriate bin.

3. The system of claim 2, wherein the characteristic of the yarn package is measured while the yarn package is the only yarn package on the second conveyor.

4. The system of claim 2, wherein the second conveyer comprising a light based sensor configured to activate the measurer when the second light based sensor senses the yarn package.

5. The system of claim 2, wherein the third conveyer comprises at least one light based sensor and a plurality of pushers configured to push the yarn package off of the third conveyer based on the measured characteristic of the yarn package.

6. The system of claim 1, wherein the measured characteristic is a weight of the yarn package.

7. A system for sorting yarn packages comprising at least one conveyer sequence comprising:
a first conveyer comprising a first light based sensor;
a second conveyer comprising a second light based sensor configured to activate a weighing mechanism when the second light based sensor senses a yarn package traversing across it;
a third conveyer comprising a third light based sensor, a plurality of doff points, and a plurality of pushers associated with the plurality of doff points and that are configured to push the yarn packages off of the third conveyer when the yarn packages reach the doff point associated with that particular pusher.

8. The system of claim 7, wherein the plurality of pushers each comprise a cylinder comprising plates that are configured to move laterally across the third conveyer.

9. The system of claim 7, wherein the weighing mechanism is a load cell, wherein the load cell is associated with the second conveyer.

10. The system of claim 7, wherein the first conveyer further comprises markings that are positioned at regularly-spaced intervals on the first conveyer.

11. The system of claim 7, further comprising a feed belt that feeds the yarn packages onto the first conveyer.

12. The system of claim 7, wherein the second conveyer is positioned between the first conveyer and the third conveyer.

13. The system of claim 7, wherein the at least one conveyer sequence comprises two conveyer sequences that operate independently of each other.

14. The system of claim 7, wherein the second light based sensor counts the number of yarn packages traversing across it.

15. A method comprising:
weighing a yarn package to determine a weight of the yarn package, wherein the weight of the yarn package is determined while the yarn package is on one of at least one conveyor; and
providing the yarn package along the at least one conveyor to one of a plurality of bins, wherein the determined weight of the yarn package is used to determine into which of the plurality of bins the yarn package is provided.

16. The method of claim 15, further comprising:
assigning one of a plurality of doff points to the yarn package based on the determined weight of the yarn package, wherein the yarn package is removed from the at least one conveyer at the assigned doff point into the one of the plurality of bins.

17. A method of sorting a plurality of yarn packages using a computerized system comprising:
feeding the plurality of yarn packages along a first conveyer to a second conveyer;
weighing the plurality of yarn packages using a weighing mechanism associated with the second conveyer to determine a weight of each of the plurality of yarn packages;
assigning one of a plurality of doff point to each of the plurality of yarn packages based on the determined weight of the yarn package;
transporting the plurality of yarn packages to a third conveyer, the third conveyer comprising a plurality of pusher assemblies associated with each of the plurality of doff points;
activating one of the pusher assemblies when the yarn package reaches its assigned doff point to push the yarn package off of the third conveyer such that the plurality of yarn packages are sorted based on their predetermined weights.

18. The method of claim 17, further comprising providing a first sensor that initiates the weighing of one of the plurality of yarn packages when it senses the presence of the yarn package.

19. The method of claim 18, further comprising the step of counting the number of yarn packages that traverse along the second conveyer using the first sensor.

20. The method of claim 17, wherein the step of activating one of the pusher assemblies comprises moving a pusher plate laterally along the third conveyer.

21. The method of claim 17, further comprising providing a second sensor that prevents a second yarn package from reaching the second conveyer if a first yarn package does not reach the third conveyer.

22. The method of claim 21, further comprising the step of shutting down the computerized system if the first yarn package does not reach the third conveyer.

23. The method of claim 21, further comprising using a third sensor to determine if the first yarn package reaches the third conveyer.

24. The method of claim 23, wherein the first sensor, the second sensor, and the third sensors are light based sensors.

25. The method of claim 17, wherein the step of activating one of the pusher assemblies comprises pushing the yarn package into a bin associated with the assigned doff point.

26. The method of claim 17, further comprising providing a sensor for detecting and sorting the yarn packages based on a color of the packages.

27. The method of claim 17, further comprising using the predetermined weight of the yarn package to determine whether the yarn package requires reprocessing.

28. A method for automatically sorting partial yarn packages comprising:
weighing and placing each partial yarn package into one of a plurality of package-receiving bins based on weight.

29. A yarn sorter comprising:
a timing conveyer positioned to feed a weighing conveyer positioned to feed a sorting conveyer, wherein the weighing conveyer is configured to weigh a yarn package to determine a weight of the yarn package, and the sorting conveyer is configured to move the yarn package off of the sorting conveyer based on the weight of the yarn package.

30. The yarn sorter of claim 29, wherein the timing conveyer is configured to feed yarn packages to the weighing conveyer at predetermined intervals.

31. A yarn sorter comprising a timing conveyer operatively coupled to a weighing conveyer operatively coupled to a sorting conveyer, wherein the weighing conveyer is configured to weigh a yarn package to determine a weight of the yarn package, and the sorting conveyer is configured to move the yarn package off of the sorting conveyer based on the weight of the yarn package.

32. The yarn sorter of claim 31, wherein the timing conveyer is configured to feed yarn packages to the weighing conveyer at predetermined intervals.

33. A yarn sorter comprising a partial yarn package handling apparatus for weighing a partial package of yarn and depositing it in one of a plurality of package receivers based on the weight of the partial package.
